(19) United States
(12) Patent Application Publication
(10) Pub. No.: US 2008/0175689 A1
(43) Pub. Date: Jul. 24, 2008

(54) VINYL SIDING FASTENER

(76) Inventor: Michael Vagedes, Florence, KY (US)

Correspondence Address: WOOD, HERRON & EVANS, LLP, 2700 CAREW TOWER, 441 VINE STREET, CINCINNATI, OH, 45202, US

(21) Appl. No.: 11/625,532

(22) Filed: Jan. 22, 2007

(51) Int. Cl. F16B 15/00; F16B 43/00

(52) U.S. Cl. 411/487; 411/533

(57) ABSTRACT

A fastener for attaching siding to the wall of a building comprises a nail having a head and a shank and a cup shaped washer. The cup shaped washer has an internal cavity that is larger than the head of the nail so that when the nail is driven into the building through the nail flange of the siding, the head of the nail cannot be forced against the siding This provides clearance between the fastener and the siding allowing the siding to expand and contract as needed.

### BACKGROUND OF THE INVENTION

Vinyl siding is generally attached to the side of a building using nails that extend through the nail flange of the vinyl siding. A nail flange includes a plurality of slots allowing the siding to be attached to the building along the entire length of the siding. The nails extend through the slots into the wall.

Because vinyl siding expands and contracts significantly, the head of the nails must not press the siding tightly against the building wall. This interferes with expansion and contraction and can cause buckling of the siding. Therefore, when one nails siding to a wall, one should not drive the nail as far into the wall as possible. Rather, a slight gap should be left between the head of the nail and the nail flange. Unfortunately, this frequently does not occur. As a result, after the siding is applied, it buckles as the temperature changes creating an unsightly appearance.

### SUMMARY OF THE INVENTION

The present invention is premised on the realization that siding can be attached to a building with a fastener that includes a nail and a cup shaped washer. The cup shaped washer fits over the shank of the nail with the open end of the washer engulfing the head of the nail. The depth of the internal cavity of the washer is slightly greater than the thickness of the head of the nail. The washer is made from a rigid material such as metal or a hard plastic. Thus, when one hammers the nail into the wall, the cup shaped washer limits the movement of the nail and prevents the nail from being driven tightly against the siding. A slight gap between the head of the nail and the inside surface of the washer allows relative expansion and contraction of the siding. Preferably, the washer is held in position with a crimp on the shank of the nail.

The objects and advantages of the present invention will be further appreciated in light of the following detailed description and drawings in which:

### BRIEF DESCRIPTION OF THE DRAWINGS

FIG. 1 is an exploded perspective view of the present invention;

FIG. 2 is a perspective view of the present invention;

FIG. 3 is a diagrammatic depiction of the fastener of the present invention used to attach siding; and

FIG. 4 is a cross sectional view of siding attached with the fastener shown in FIG. 2.

### DETAILED DESCRIPTION

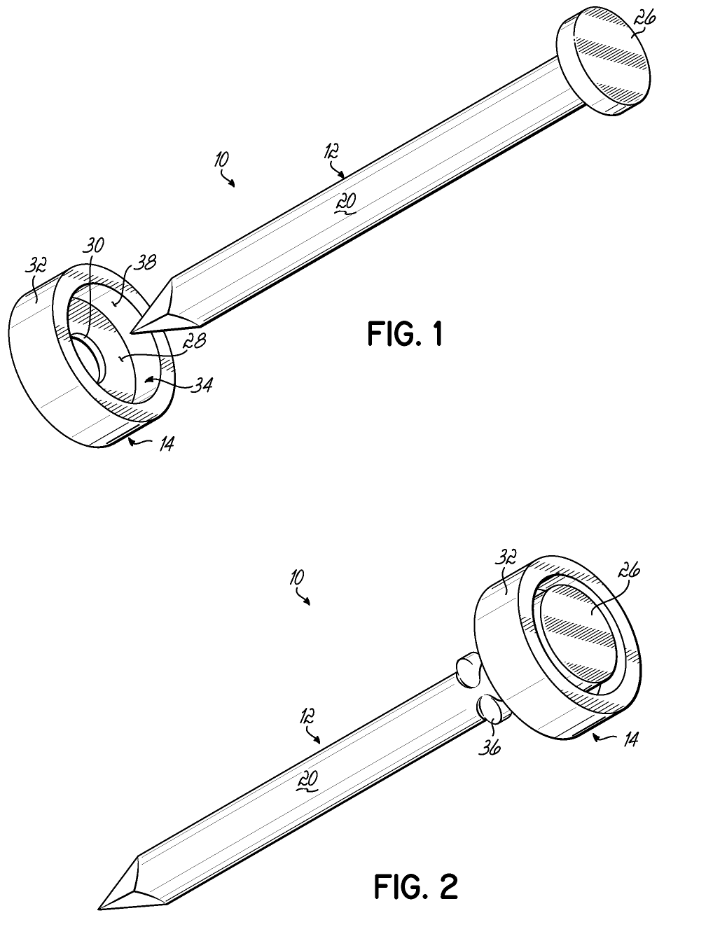

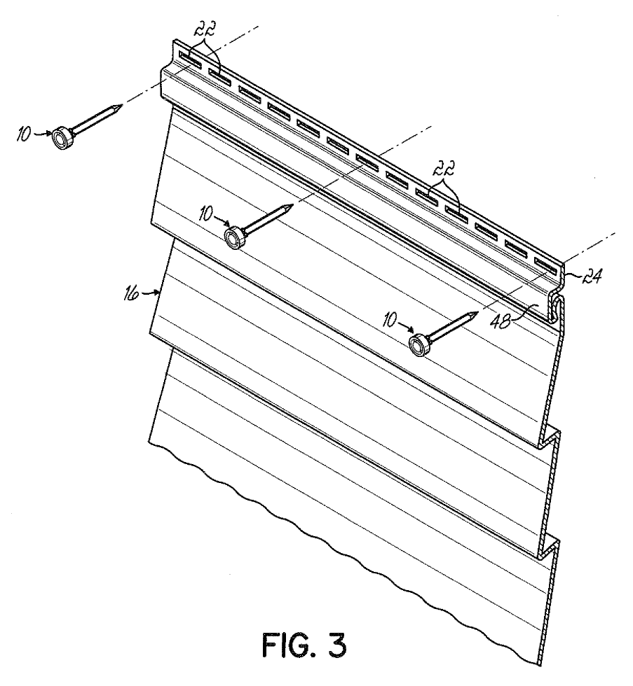

As shown in FIG. 1, a fastener 10 includes a nail 12 and a rigid cup shaped washer 14. This is used to attach siding 16 to the side wall 18 of a building by extending the shank 20 through a slot 22 in the nail flange 24 of the vinyl siding 16.

As shown in FIGS. 1 and 2, the nail 12 includes a shank 20 and a head 26.

The washer includes a bottom wall 28 having a central opening slightly larger than the shank 20 of the nail 12 and a side wall 32. The bottom wall 28 and side wall 32 combine to form an interior disc shaped cavity 34. The shank 20 of the nail 12 extends through the central opening 30 in the bottom wall 28 of the washer 14. Nail 12 can be held in place by a crimp 36 on the shank 20 of the nail 12.

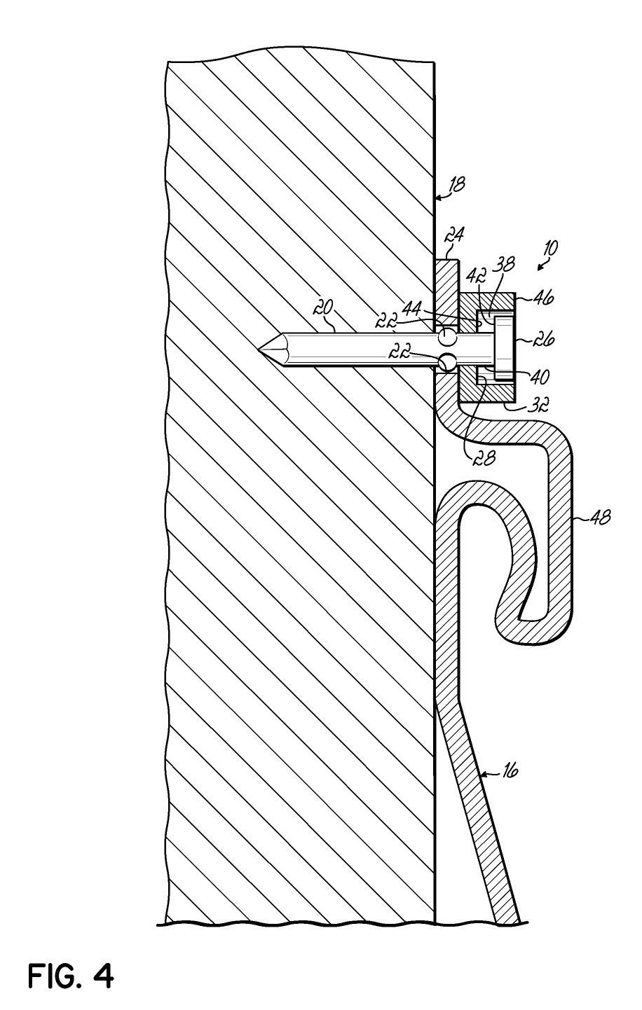

As shown in FIG. 4, the inner side wall 38 of the cup shaped washer 14 has a depth that exceeds the thickness of the head 26 of the nail 12.

The fastener 10 is formed by combining the nail 12 with the washer 14. The diameter of the shank 20 of nail 12 should be only slightly smaller than the diameter of the central opening 30. In this manner, the head 26 of nail 12 will not engage the rim 46 of washer 14 once the washer is positioned over the shank of the nail because there is a clearance or gap 40 between the bottom 42 of the head 26 of nail 12 and the inner surface 44 of washer 14. An optional crimp 36 can be formed at the upper portion of shank 20. The crimp 36 is optional and merely keeps the washer in place.

The washer can be modified in various manners as long as the side wall 32 remains a rigid material, preferably metal. The interior surface can be formed from an elastomeric material in whole or in part, which may eliminate any benefit from using the crimped shank. The depth of sidewall 32 can be varied as long as it does not exceed the depth of the connecting portion 48 of siding 16, which would interfere with positioning the next section of vinyl siding.

When the fastener 10 is used to attach the siding 16 to the wall 18 of a building, the shank 20 of the nail 12 is extended through a slot 22 in the nail flange 24 of the vinyl siding 16. A hammer is used to drive the nail into the wall 18, as shown in FIG. 4. Eventually, the washer 14 will engage the nail flange 24 and prevent the hammer from driving the nail 12 any further into the wall 18 of the building. This leaves gap 40 between the bottom 42 of the head 26 of the nail 12 and the inner surface 44 of the cup shaped washer 14. This gap 40, which should be approximately 0.03 to 0.05 inch and preferably about 0.04 inch, prevents the fastener from binding the siding 16 and allows the vinyl siding 16 to move laterally during expansion and contraction.

Because the cup shaped washer 14 is formed from a hardened metal, the installer cannot force the nail 12 any farther into the wall 18 than would be permitted by the washer 14. This prevents a careless installer from improperly installing the vinyl siding 16.

This has been a description of the present invention along with the preferred method of practicing the present invention. However, the invention itself should only be defined by the appended claims.

1. A fastener for vinyl siding comprising a nail having a shank and a head, and a cup shaped washer having a bottom wall with a central opening, and a peripheral side wall, said bottom wall and side wall defining an internal cavity wherein said internal cavity has a depth greater than a thickness of the head of said nail and wherein said side wall has an inner diameter greater than an outer diameter of the head of the nail, and
wherein the side wall of said washer has a hardness effective to limit the distance said nail can be hammered into a surface.

2. The fastener claimed in claim 1 further comprising a crimp on the shank of said nail wherein said washer is positioned between said crimp and the head of said nail.

3. The fastener claimed in claim 1 wherein said head of said nail is located in said cavity and wherein a clearance of at least about 0.03 inch is provided between said bottom wall and a bottom surface of said head of said nail.

4. Vinyl siding attached to a wall of a building with a fastener extended through slots in a nail flange of said vinyl siding wherein said fastener comprises a nail having a shank and a head, and a cup shaped washer having a bottom wall with a central opening, and a peripheral side wall, said bottom wall and side wall defining an internal cavity wherein said internal cavity has a depth greater than a thickness of the head of said nail and wherein said side wall has an inner diameter greater than an outer diameter of the head of the nail and wherein the head of said nail does bind said siding.

5. The fastener claimed in claim 1 wherein said washer is formed from a hard metal.
